(19) United States
(12) Patent Application Publication
(10) Pub. No.: US 2018/0355895 A1
(43) Pub. Date: Dec. 13, 2018

(54) APPARATUS FOR FASTENING WIRE

(71) Applicant: SHIN KYUNG Inc., Busan (KR)

(72) Inventors: Ki Ho HA, Busan (KR); Min Woo HA, Busan (KR)

(21) Appl. No.: 15/617,046

(22) Filed: Jun. 8, 2017

(51) Int. Cl. F16B 2/08; A41F 1/00

(52) U.S. Cl. CPC F16B 2/08; A41F 1/00

(57) ABSTRACT

A wire tightening device is provided, which includes: a housing having a through body part adapted to be inserted into a coupling opening formed on an object to be tightened and having a cylindrical inner surface on which a ratchet type gear is formed and a support part protruding from the outer periphery of the lower portion of the through body part in such a manner as to be constrained on one surface of an edge peripheral portion of the coupling opening; a rotary cover rotatably coupled to the top end periphery of the through body part; and a fastening part selectively engaged with the ratchet type gear in such a manner as to be constrained in rotation and adapted to apply a tensile force to a wire connected to both sides of the object to be tightened.

### GRACE PERIOD INVENTOR DISCLOSURE STATEMENT

This application is filed under the grace period exception of AIA 35 U.S.C. 102(b) (1) based on KR Application No. 10-2016-0045999, filed Apr. 15, 2016, which was issued as KR Patent 10-1723573 on Mar. 30, 2017.

### BACKGROUND OF THE INVENTION

### Field of the Invention

The present invention relates to a wire tightening device, and more particularly, to a wire tightening device that is capable of being easily mounted on an object to be tightened such as caps, shoes and so on to improve the conveniences of use.

### Background of the Related Art

Generally, wire tightening devices are applied to a variety of objects that are worn or taken off through wires, such as shoes, caps and the like. Among various use examples, in this case, the wire tightening devices are used for the caps worn on heads, but in addition thereto, they may be used for different kinds of objects such as head wear accessories, belts, gloves, shoes, snow boards, water skies and so on.

On the other hand, FIGS. 1a and 1b are perspective views showing cap tightening devices in conventional practices.

As shown in FIGS. 1a and 1b, the head wear accessories like caps are worn on a wearer's head so as to protect his or her head from hot air, cold air or impacts, and accordingly, the conventional caps include tightening devices 3, 6a and 6b adapted to adjust the circumferences of the caps according to his or her head circumference to allow them to be fitted to his or her head, thereby preventing the caps from being separated from the wearer's head due to external environments like strong motions during his or her exercise or wind.

In more detail, the caps include bodies 1 and 4 adapted to surround the head and visors 2 and 5 coupled to the front sides of the bodies 1 and 4, and further, a semicircular opening la is formed on the rear side of the body 1.

At this time, the wire tightening devices are provided in a variety of ways, such as a way using a belt and a buckle, a snap way using protrusions and grooves, a way using a tightening wire 6a and a holder 6b fixing the tightening wire 6a in the state of pulling the tightening wire 6a, and the like.

If the wire tightening devices in the conventional practices are reduced in size or tightened according to the circumference of the wearer's head, however, a portion of a wire or belt corresponding to the length of the adjusted circumference of the cap is exposed to the outside of the cap, thereby making the outer appearance of the cap look bad, and further, the conventional caps have to be reduced in size or tightened by means of his or her both hands, thereby causing the inconveniences of use.

So as to solve the above-mentioned problems, accordingly, there is proposed a wire tightening device having a hard wire which replaces the conventional belt or wire in such a manner as to be connected to one side of the cap and the other side thereof, and only through rotation manipulation, accordingly, the wire is tightened or untightened.

However, the conventional wire tightening device is coupled to the cap by means of an adhesive or sewing, thereby making it difficult to install the wire tightening device on the cap and further to exchange or separate the wire tightening device once installed.

### SUMMARY OF THE INVENTION

Accordingly, the present invention has been made in view of the above-mentioned problems occurring in the prior art, and it is an object of the present invention to provide a wire tightening device that is capable of being easily mounted on an object to be tightened such as caps, shoes and so on to improve the conveniences of use.

To accomplish the above-mentioned object, according to the present invention, there is provided a wire tightening device including: a housing having a through body part adapted to be inserted into a coupling opening formed on an object to be tightened and having a cylindrical inner surface on which a ratchet type gear is formed and a support part protruding from the outer periphery of the lower portion of the through body part in such a manner as to be constrained on one surface of an edge peripheral portion of the coupling opening; a rotary cover rotatably coupled to the top end periphery of the through body part in such a manner as to rotate by means of an external force; a fastening part selectively engaged with the ratchet type gear in such a manner as to be constrained in rotation and adapted to apply a tensile force to a wire connected to both sides of the object to be tightened; and a fixing cap having a coupling hole formed on the center thereof in such a manner as to insertedly pass the through body part therethrough to allow the fixing cap to be seated on the other surface of the edge peripheral portion of the coupling opening, while being pressurizedly coupled to the support part in such a manner as to clamp the edge peripheral portion of the coupling opening, wherein at least one of the top of the support part and the underside of the fixing cap has a plurality of wedge protrusions formed thereon, the plurality of wedge protrusions becoming small in width in the circumferential direction thereof as the plurality of wedge protrusions goes toward the end portions thereof, so that the plurality of wedge protrusions is press-fitted to the edge peripheral portion of the coupling opening when the fixing cap comes into close contact with the support part.

According to the present invention, desirably, one of the top of the support part and the underside of the fixing cap has a plurality of elastic hooks formed thereon in such a manner as to be elastically deformed in a radial direction, each elastic hook having a locking protrusion formed on one surface of the inner surface and the outer surface of the end portion thereof, the locking protrusion having a stepped projection formed thereon, so that the plurality of elastic hooks passes through a plurality of through holes formed on the edge peripheral portion of the coupling opening, and the other of the top of the support part and the underside of the fixing cap has a plurality of coupling portions formed thereon in such a manner as to insertedly and lockedly couple the plurality of elastic hooks thereto.

According to the present invention, desirably, each locking protrusion has an inclined portion formed inclinedly toward the other surface of the inner and outer surfaces of the end portion of each elastic hook as the locking protrusion goes toward the lower side along the portion corresponding to the lower portion of the stepped projection, and each coupling portion comprises a mounting hole having a locking projection formed on one side edge facing the inclined portion in such a manner as to lock the stepped projection thereonto and a separation hole connected to one side in the circumferential direction of the mounting hole in such a manner as to be expanded on one side edge to separate the stepped projection therefrom.

According to the present invention, desirably, while the lower end periphery of the rotary cover is being supportingly coupled to the top surface portion of the fixing cap, the housing has a ring-shaped cover coupling groove formed concaved inwardly in a radial direction thereof along the height corresponding to the top surface portion of the fixing cap along the outer peripheral surface thereof, the rotary cover has a plurality of hook protrusions protruding from the inner peripheral surface of the lower end thereof in such a manner as to be insertedly and hook-coupled to the cover coupling groove, and the housing has a support surface formed on the underside thereof in such a manner as to roundedly protrude downwardly from the underside of the support part.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIGS. 1a and 1b are perspective views showing cap tightening devices in conventional practices;

FIG. 2 is a perspective view showing an object to which a wire tightening device according to the present invention is applied;

FIG. 3 is a sectional view showing the wire tightening device according to the present invention;

FIG. 4 is a rear view showing a fixing cap of the wire tightening device according to the present invention; and

FIG. 5 is a top view showing a housing of the wire tightening device according to the present invention.

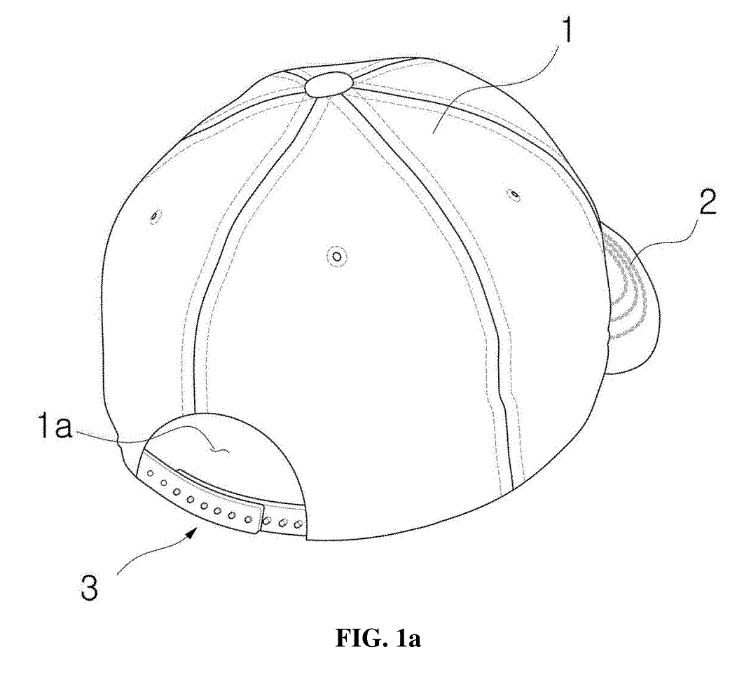

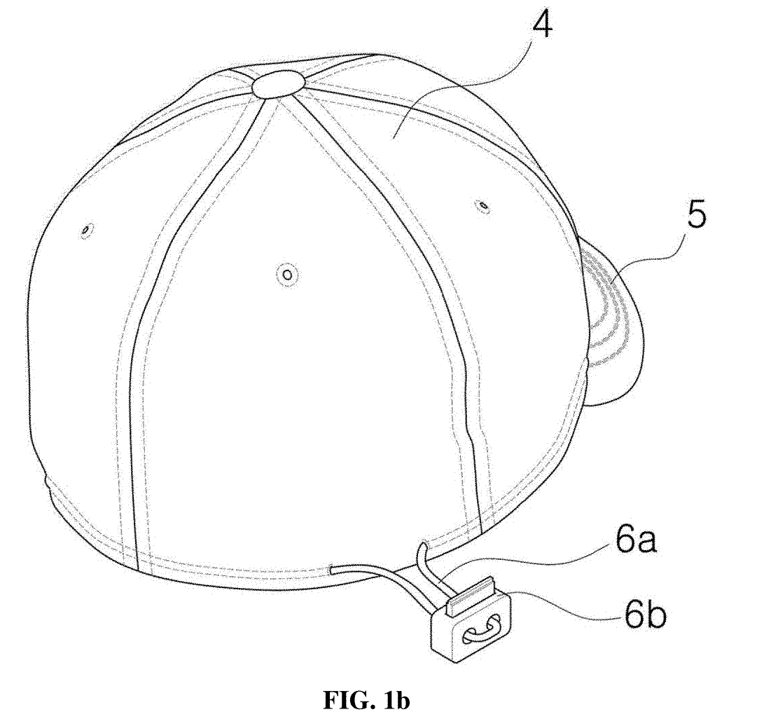

### DETAILED DESCRIPTION OF THE PREFERRED EMBODIMENTS

Hereinafter, an explanation on a wire tightening device according to the present invention will be in detail given with reference to the attached drawings.

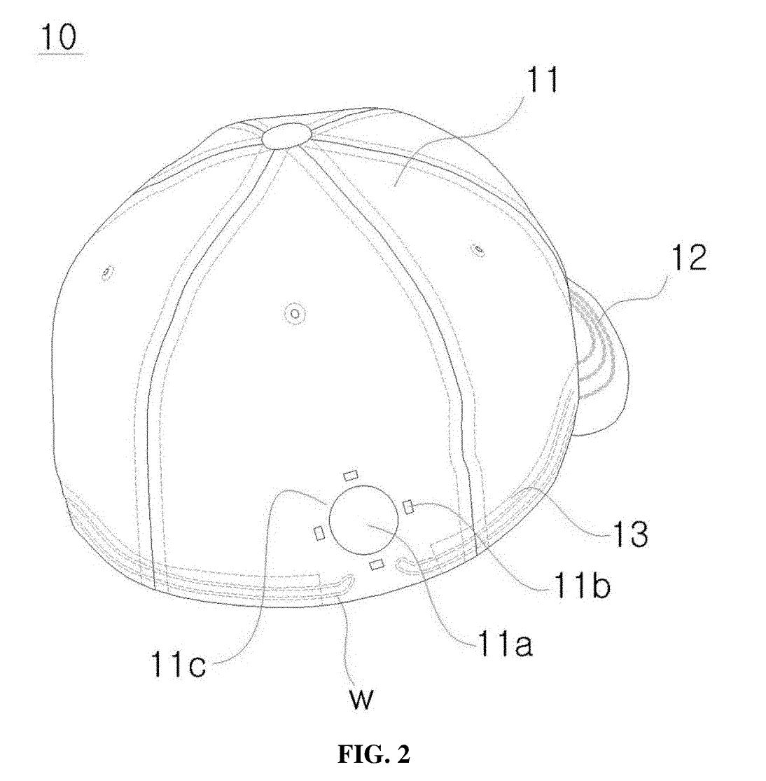

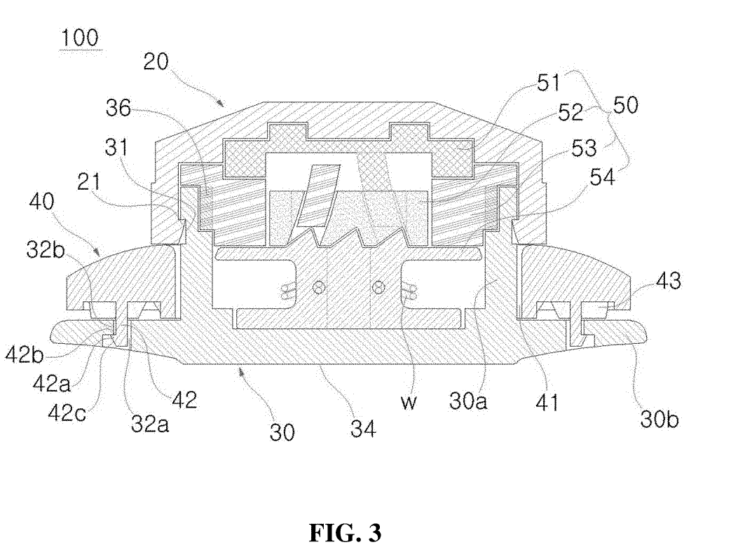

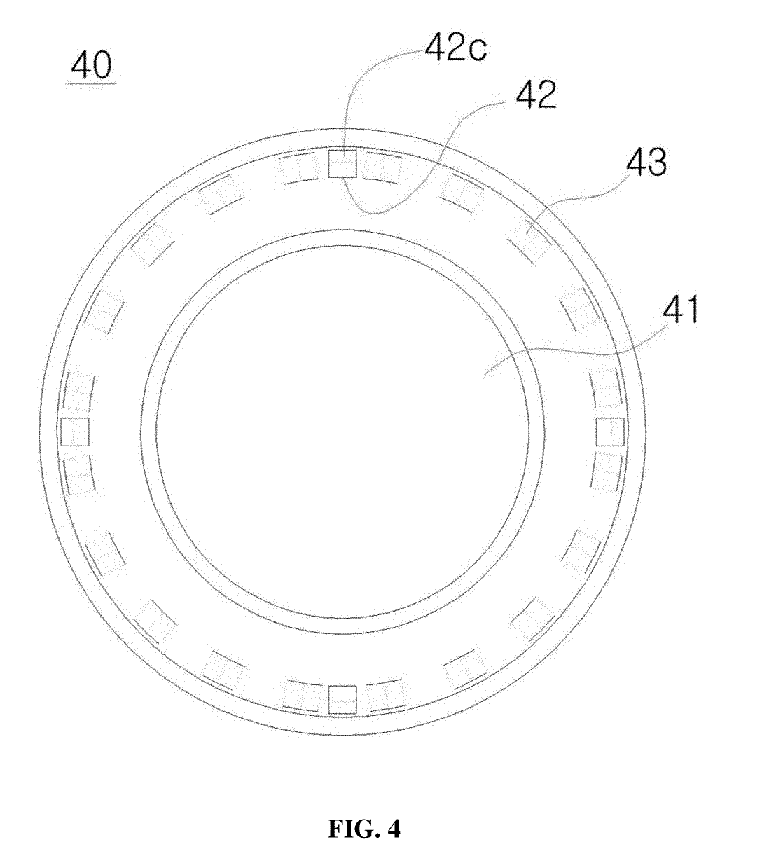

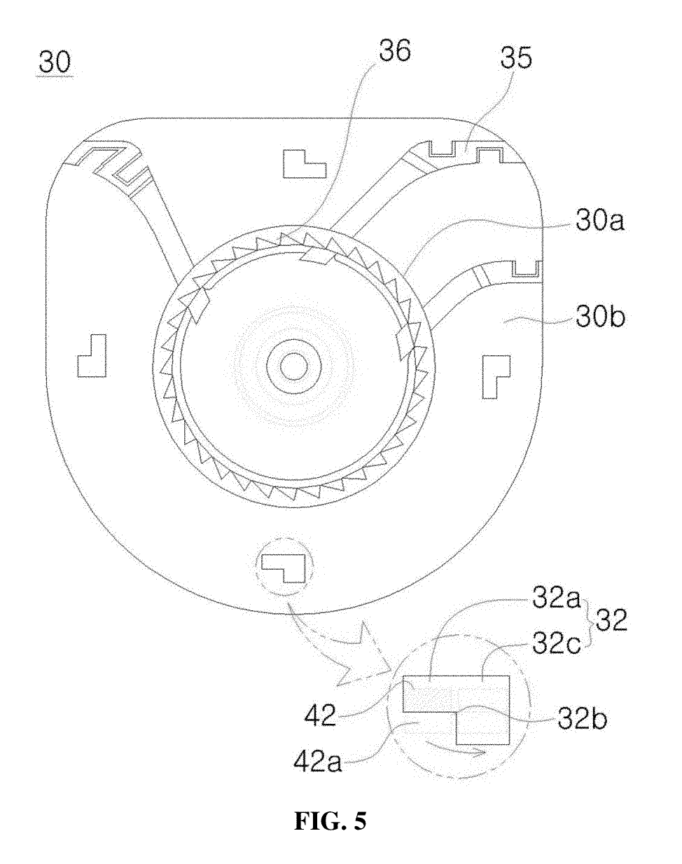

FIG. 2 is a perspective view showing an object to which a wire tightening device according to the present invention is applied, FIG. 3 is a sectional view showing the wire tightening device according to the present invention, FIG. 4 is a rear view showing a fixing cap of the wire tightening device according to the present invention, and FIG. 5 is a top view showing a housing of the wire tightening device according to the present invention.

As shown in FIGS. 2 to 5, a wire tightening device 100 according to the present invention includes a housing 30, a rotary cover 20, a tightening part 50 and a fixing cap 40.

In this case, the wire tightening device 100 may be applied to various objects to be tightened by a wire w, such as caps, shoes, and so on, and according to the present invention, for example, the case wherein the wire tightening device 100 is applied to a cap 10 will be illustrated and explained.

At this time, as shown in FIG. 2, the cap 10 includes a body 11 adapted to surround a wearer's head and a visor 12 protruding forwardly from the body 11. Further, a circumference adjustment part 13 is provided in such a manner as to allow a fabric to be added or rolled up to a form of a tunnel along the lower periphery of the inner surface of the body 11, and the wire W is disposed inside the circumference adjustment part 13.

In this case, the wire W is located along the periphery of the body 11, and the wire tightening device 100 is exposedly connected to both ends of the circumference adjustment part 13. As the wire tightening device 100 is manipulated, accordingly, the tensile force caused by the wire tightening device 100 is applied to the wire W, so that the size of the cap can be appropriately adjusted to the circumference of the wearer's head.

At this time, a coupling opening 11a is formed between both ends of the circumference adjustment part 13. In this case, the coupling opening 11a is a portion to which the wire tightening device 100 is coupled, which may be formed at the back of the body 11. So as to be easily manipulated by the wearer, of course, the coupling opening 11a may be formed at the side or front of the body 11.

On the other hand, as shown in FIG. 3, the housing 30 is a part for fixing the wire tightening device 100 to the cap 10 as an object to be tightened together with the fixing cap 40, and desirably, the housing 30 is made of a resin material which is light and has high stiffness and a given elastic force.

At this time, the housing 30 includes a through body part 30a and a disc-shaped support part 30b protruding from the outer periphery of the through body part 30a, and desirably, the through body part 30a and the support part 30b may be formed unitarily with each other by means of injection molding.

In more detail, the through body part 30a is inserted into the coupling opening 11a formed on the cap 10 and has a cylindrical inner peripheral surface on which a ratchet type gear 36 is formed. That is, the through body part 30a has a shape of a container whose one surface is open, and the ratchet type gear 36 is formed along the inner peripheral surface of the upper portion of the through body part 30a.

At this time, the sectional area of the through body part 30a corresponds to that of the coupling opening 11a, and the through body part 30a passes through the body 11 via the coupling opening 11a.

Further, the support part 30b protrudes outwardly in a radial direction from the outer peripheral surface of the lower portion of the through body part 30a in such a manner as to be constrained on one surface of an edge peripheral portion 11c of the coupling opening 11a. In this case, desirably, it is to be understood that the edge peripheral portion 11c is a fabric portion connected to the edge periphery of the coupling opening 11a of the cap 10.

Furthermore, one surface of the edge peripheral portion 11c of the coupling opening 11a means the inner side surface of the body 11 in FIG. 2, and in the state where the rotary cover 20 is located on top of the wire tightening device 100, one surface of the edge peripheral portion 11c may be designated as the bottom surface thereof. Under the arrangement state as shown in FIG. 3, hereinafter, the position relations between the respective components of the wire tightening device 100 according to the present invention will be explained.

At this time, the support part 30b protrudes to a given width exceeding the sectional area of the coupling opening 11a. Accordingly, the housing 30 is located inside the body 11, and if the through body part 30a is inserted into the coupling opening 11a, the support part 30b is constrained on the edge peripheral portion 11c of the coupling opening 11a.

Moreover, the wire W is inserted into the support part 30b, and at this time, desirably, slits 35 are formed to communicate with the interior of the through body part 30a. In this case, the slits 35 are formed on one side and the other side of the support part 30b.

That is, the wire w exposed to both ends of the circumference adjustment part 13 is connected to a reel part 54 disposed inside the through body part 30a along the slits 35.

At this time, the slits 35 have the shapes corresponding to the wire W exposed to both ends of the circumference adjustment part 13, and in this case, a pair of slits 35 is formed on one side or the other side of the support part 30b, respectively. Otherwise, a pair of slits 35 is formed on one side of the support part 30b and a slit 35 on the other side thereof, or a slit 35 is formed on one side of the support part 30b and a pair of slits 35 on the other side thereof.

As a result, a process for connecting the wire W to the reel part 54 can be more easily carried out, and further, a portion of the wire W exposed to the outside of the circumference adjustment part 13 and the wire tightening device 100 can be minimized.

In the process where the wire W is tightened or untightened, accordingly, the damage caused by the abrasion of the wire W can be reduced to improve the durability of the product, and further, the contact of the wire W with the wearer's head can be prevented to provide a more comfortable wearing sense to the wearer.

On the other hand, the rotary cover 20 is rotatably coupled to the top end periphery of the through body part 30a and thus rotates by means of an external force. That is, the rotary cover 20 is a part manipulated actually by the wearer.

Further, the fastening part 50 is selectively engaged with the ratchet type gear 36 in such a manner as to be constrained in rotation, so that it provides a tensile force to the wire W connected to both sides of the object to be tightened.

In more detail, the fastening part 50 includes a cam base 53 engaged with the ratchet type gear 36 in such a manner as to be constrained in rotation in the other direction, an elevating cam 52 adapted to be elevated inside the cam base 53, a cam driver 51 coupled to the underside surface of the rotary cover 20 to elevatingly drive the elevating cam 52 according to the direction of rotation, and the reel 54 rotatably disposed inside the through body part 30a in such a manner as to wind the wire W therearound.

In this case, gear matching portions are formed on the underside of the elevating cam 52 and the top of the reel 54 in such a manner as to be engaged with each other, and if the elevating cam 52 moves down, the reel 54 rotates integrally with the elevating cam 52. If the elevating cam 52 moves up, contrarily, the reel 54 rotates independently, while being separated from the elevating cam 52.

At this time, the elevating cam 52 is elevatable inside the cam base 53 in such a manner as to rotate integrally with the cam base 53, and further, the elevating cam 52 moves up and down by means of the cam driver 51 rotating integrally with the rotary cover 20.

If the rotary cover 20 rotates in one direction, in this case, the elevating cam 52 moves down by means of the cam driver 51, so that the elevating cam 52, the cam base 53 and the reel 54 rotate integrally with each other, thereby winding the wire W around the reel 54.

At this time, the cam base 53 is constrained in rotation in the other direction by means of the ratchet type gear 36, so that the reel 54 around which the wire W is wound up is also constrained in rotation in the other direction, thereby preventing the wire W from being wound off.

If the rotary cover 20 rotates in the other direction, further, the elevating cam 52 moves up by means of the cam driver 51, and the coupling between the reel 54 and the elevating cam 52 is released so that the reel 54 rotates independently, thereby allowing the wire W to be pulledly wound off.

If the rotary cover 20 rotates in one direction by means of the wearer's manipulation, like this, the wire W is wound up on the reel 54 to allow the circumference of the cap 10 to be adjusted to the wearer's head size, thereby maintaining the adjusted circumference of the cap 10. If the rotary cover 20 rotates in the other direction, contrarily, the tensile force of the wire W is removed to allow the circumference of the cap 10 to be extended, thereby making it easy to wear the cap 10.

In addition to the method where the rotary cover 20 rotates in the other direction to allow the reel 54 to rotate independently, of course, the rotary cover 20 may pull upwardly to allow the reel 54 to rotate independently, and such operation and structure have been disclosed in Korean Patent Nos.1249420, 1053551, 953398, and 1028468, which will be easily carried out by those skilled in the art. Accordingly, a detailed explanation on them will be avoided for the brevity of the description.

On the other hand, as shown in FIGS. 3 and 4, the fixing cap 40 has a coupling hole 41 formed on the center thereof in such a manner as to insertedly pass the through body part 30a therethrough and is adapted to be seated on the other surface of the edge peripheral portion 11c of the coupling opening 11a, while being pressurizedly coupled to the support part 30b in such a manner as to clamp the edge peripheral portion 11c of the coupling opening 11a.

In this case, it is to be understood that the other surface of the edge peripheral portion 11c of the coupling opening 11a is the opposite side surface to one surface on which the support part 30b is constrained.

In more detail, the fixing cap 40 has a shape of a ring having an outer diameter larger than the diameter of the coupling opening 11a, and desirably, the inner diameter of the coupling hole 41 corresponds to the outer diameter of the through body part 30a.

At this time, the fixing cap 40 is pressurized toward the support part 30b along the outer peripheral surface of the through body part 30a, and as the edge peripheral portion 11c of the coupling opening 11a is fixedly clamped between the fixing cap 40 and the support part 30b, the wire tightening device 100 can be located on the object to be tightened.

In this case, if the outer diameter of the rotary cover 20 is larger than the inner diameter of the coupling hole 41, the housing 30 is fixed by means of the fixing cap 40 after the housing 30 is first located on the coupling opening 11a of the object to be tightened, and next, the tightening part 50 and the rotary cover 20 are coupled to the housing 30.

If the outer diameter of the rotary cover 20 is smaller than the inner diameter of the coupling hole 41, the housing 30 is located on the coupling opening 11a of the object to be tightened after the tightening part 50 and the rotary cover 20 are first coupled to the housing 30, and next, the housing 30 is fixed by means of the fixing cap 40. Hereinafter, for example, the case wherein the outer diameter of the rotary cover 20 is larger than the inner diameter of the coupling hole 41 will be illustrated and explained.

On the other hand, desirably, a plurality of wedge protrusions 43 is formed on at least one of the top of the support part 30b and the underside of the fixing cap 40.

That is, the wedge protrusions 43 may be formed on the top of the support part 30b, and otherwise, they may be formed on the underside of the fixing cap 40. Hereinafter, for example, the case wherein the wedge protrusions 43 are formed on the underside of the fixing cap 40 will be illustrated and explained.

In this case, the wedge protrusions 43 are formed in a circumferential direction on the underside of the fixing cap facing the top of the support part 30b. At this time, the wedge protrusions 43 are equally spaced apart from each other.

Even if the fabric constituting the object to be tightened has high stiffness, accordingly, a force required for pressurizing and fixing the fixing cap 40 toward the support part 30b can be reduced.

At this time, desirably, the wedge protrusions 43 become small in width in the circumferential direction thereof as they go toward their end portion so that they can be press-fitted to the edge peripheral portion 11c of the coupling opening 11a when the fixing cap 40 comes into close contact with the support part 30b.

That is, the portions of the wedge protrusions 43 connected to the fixing cap 40 are relatively large, and the portions of the wedge protrusions 43 extended toward the support part 30b are relatively small in width in the circumferential direction thereof, so that they have the end portions having the shapes of blades extended radially and also have both radial sides having vertical sections.

Accordingly, the wedge protrusions 43 can be easily press-fitted to the edge peripheral portion 11c of the coupling opening 11a having a given thickness by means of the blade-shaped end portions when the fixing cap 40 comes into close contact with the support part 30b.

Further, the wedge protrusions 43 have the blade-shaped end portions having given widths in the radial direction thereof and also have both radial sides having vertical sections, so that while the wedge protrusions 43 are being press-fitted to the edge peripheral portion 11c, their fixing forces to the circumferential and radial directions can be remarkably increased, and the external force applied upon the manipulation of the wire tightening device 100 is distributedly supported in the radial directions of the end portions of the wedge protrusions 43, thereby minimizing the damage of the fabric like the edge peripheral portion 11c.

Of course, the wedge protrusions 43 may be formed on both of the top of the support part 30b and the underside of the fixing cap 40. Otherwise, the wedge protrusions 43 are formed on one of the top of the support part 30b and the underside of the fixing cap 40, and a plurality of wedge grooves corresponding to the wedge protrusions 43 may be formed on the other.

On the other hand, a plurality of elastic hooks 42 is located on one of the top of the support part 30b and the underside of the fixing cap 40 in such a manner as to be elastically deformed in a radial direction thereof.

Further, a plurality of coupling portions 32 is formed on the other of the top of the support part 30b and the underside of the fixing cap 40 in such a manner as to insertedly and lockedly couple the plurality of elastic hooks 42 thereto.

That is, the elastic hooks 42 may be formed on the underside of the fixing cap 40, and if so, the coupling portions 32 are desirably formed on the top of the support part 30b.

Further, the elastic hooks 42 may be formed on the top of the support part 30b, and if so, the coupling portions 32 are desirably formed on the underside of the fixing cap 40.

In more detail, a plurality of through holes 11b is formed on the edge peripheral portion 11c of the coupling opening 11a. At this time, the through holes 11b are formed correspondingly to the elastic hooks 42, and the elastic hooks 42 pass through the through holes 11b and are then inserted into the coupling portions 32.

In this case, each elastic hook 42 desirably has a locking protrusion 42a formed on one surface of the inner surface and the outer surface of the end portion thereof, and the locking protrusion 42a has a stepped projection 42b formed thereon.

That is, the locking protrusion 42a may be formed on the inner surface of the end portion of the elastic hook 42 or on the outer surface of the end portion thereof, and otherwise, it may be formed on both of them. Hereinafter, for example, the case wherein the locking protrusion 42a is formed on the outer surface of the end portion of the elastic hook 42 will be explained.

At this time, the locking protrusion 42a protrudes from the lower portion of the outer surface adjacent to the lower end portion of the elastic hook 42, and as the locking protrusion 42a protrudes, the stepped projection 42b is formed between the upper and lower portions of the outer surface of the elastic hook 42.

In this case, desirably, the elastic hooks 42 are equally spaced apart from each other on the underside of the fixing cap 40 along the circumferential direction of the fixing cap 40. For example, the elastic hooks 42 are located at two positions at intervals of 180°, at three positions at intervals of 120°, or at four positions at intervals of 90°.

At this time, each elastic hook 42 protrudes to a shape of a bar which has an upper portion adjacent to the underside of the fixing cap 40 and having a given thickness, so that the width in the circumferential direction of the bar-shaped protruding portion of the elastic hook 42 is larger than the thickness in the radial direction thereof, thereby allowing the elastic hook 42 to be elastically deformed in the radial direction.

Further, the number of coupling portions 32 is the same as that of the elastic hooks 42, and the positions of the coupling portions 32 correspond to those of the elastic hooks 42. Also, the fixing cap 40 is coupled to the support part 30b in the state where the coupling portions 32, the elastic hooks 42 and the through holes 11b have been aligned.

In more detail, if the through body part 30a of the housing 30 is disposed to pass through the coupling opening 11a, the coupling portions 32 and the through holes 11b are aligned, while the installation angle of the housing 30 is being adjusted so that the slits 35 formed on both sides of the support part 30b are located on both sides of the circumference adjustment part 13.

Further, if the fixing cap 40 is mounted along the outer periphery of the through body part 30a, the angle of the fixing cap 40 is adjusted to allow the elastic hooks 42 to face the through holes 11b, and next, the fixing cap 40 is pressurized toward the support part 30b.

At this time, the end portions of the elastic hooks 42 pass through the through holes 11b and are then inserted into the coupling portions 32. In this case, the locking protrusions 42a are lockedly coupled to the coupling portions 32, so that the edge peripheral portion 11c of the coupling opening 11a is fixedly clamped between the fixing cap 40 and the support part 30a.

Like this, only if the fixing cap 40 is mounted along the outer periphery of the through body part 30a inserted into the coupling opening 11a and pushes toward the support part 30b, the elastic hooks 42 are hook-coupled to the coupling portions 32, and then, the edge peripheral portion 11c of the coupling opening 11a is fixedly clamped between the fixing cap 40 and the support part 30a, so that it is possible to install the wire tightening device 100 on the object to be tightened only by means of one-touch pressurization, thereby remarkably improving the conveniences of use for the product.

On the other hand, each locking protrusion 42a desirably has an inclined portion 42c formed inclinedly toward the other surface of the inner and outer surfaces of the end portion of each elastic hook 42 as it goes toward the lower side along the portion corresponding to the lower portion of the stepped projection 42b.

That is, if the locking protrusion 42a protrudes from the outer surface of the elastic hook 42, the inclined portion 42c is inclined toward the inner surface of the elastic hook 42 as it goes toward the lower side of the locking protrusion 42a.

At this time, the locking protrusion 42a has a side section of an inverted right triangle which has a height protruding from the elastic hook 42 decreased as it goes toward the lower portion thereof.

In this case, desirably, it is to be understood that the outer surface of the elastic hook 42 means the outer peripheral surface of the fixing cap 40 in the radial direction thereof, and the inner surface of the elastic hook 42 means the inner peripheral surface of the fixing cap 40 in the radial direction thereof.

On the other hand, as shown in FIG. 5, each coupling portion 32 includes a mounting hole 32a having a locking projection 32b formed on one side edge facing the inclined portion 42c in such a manner as to lock the stepped projection 42b thereonto and a separation hole 32c connected to one side in the circumferential direction of the mounting hole 32a in such a manner as to be expanded on one side edge to separate the stepped projection 42c therefrom.

In more detail, each coupling portion 32 includes the mounting hole 32a and the separation hole 32c which are connected to each other in the circumferential direction thereof. At this time, the widths of the mounting hole 32a and the separation hole 32c correspond to the width in the circumferential direction of the elastic hook 42, and also, the mounting hole 32a and the separation hole 32c have given sizes capable of passing the elastic hook 42 having the locking protrusion 42a therethrough.

In the state where the fixing cap 40 is mounted on the through body part 30a, in this case, the mounting hole 32a is formed as a hole passing the elastic hook 42 therethrough, and the hole is formed at the position misaligned toward the inner side in the radial direction from the portion corresponding to the elastic hook 42 located at a restoring position at which the elastic hook 42 is not elastically deformed in the support part 30b.

Next, the locking projection 32b protrudes from the inner side in the radial direction on the edge side facing the locking protrusion 42a at the restoring position of the elastic hook 42. At this time, desirably, the locking projection 32b is formed correspondingly to the widths in the radial direction and in the circumferential direction of the stepped projection 42b.

Further, the separation hole 32c is formed on the side portion in the circumferential direction of the mounting hole 32a, and the separation hole 32c communicates with the mounting hole 32a.

Also, the separation hole 32c is formed to a position facing the elastic hook 42 and the locking protrusion 42a which are located at the restoring position at which the elastic hook 42 is not elastically deformed.

That is, if the elastic hook 42 is located above the mounting hole 32a at the restoring position thereof, the inclined portion 42c of the locking protrusion 42a faces the locking projection 32b.

At this time, if the elastic hook 42 moves to the mounting hole 32a, the inclined portion 42c slides along the upper edge of the locking projection 32b and is then deformed elastically toward the inner side in the radial direction of the elastic hook 42.

After that, the deformed elastic hook 42 passes through the mounting hole 32a and is then inserted into the mounting hole 32a, so that the locking protrusion 42a passes through the locking projection 32b, thereby allowing the elastic hook 42 to be elastically restored to the outer side in the radial direction thereof.

At this time, the stepped projection 42b formed on the upper portion of the locking protrusion 42a is locked onto the underside of the locking projection 32b, and accordingly, the elastic hook 42 is lockedly coupled to the coupling portion 32.

In this case, the separation hole 32c formed in the circumferential direction of the mounting hole 32a is located to pass the elastic hook 42 and the locking protrusion 42 being in the elastically restoring state therethrough. That is, the separation hole 32c is provided to the shape from which the locking projection 32b is removed.

In the state where the elastic hook 42 is lockedly coupled to the coupling portion 32, accordingly, if the fixing cap 40 rotates to move the elastic hooks 42 to the separation holes 32c, the locking protrusions 42a are deviated from the locking projections 32b, and the elastic hooks 42 are separated from the separation holes 32c.

Like this, each coupling portion 32 includes the mounting hole 32a onto which the elastic hook 42 is locked and the separation hole 32c from which the elastic hook 42 is separated, and only if the fixing cap 40 rotates to a given angle, accordingly, the hook coupling is released and the separation from the object to be tightened is carried out, so that the maintenance and exchanging work can be easily performed, without any damage on the fabric, thereby remarkably improving the conveniences of use for the product.

In this case, the length of the elastic hook 42 exceeds the protruding height of each wedge protrusion 43 and the thickness in up and down directions of the locking projection 32b. Considering the thickness of the fabric, that is, the elastic hook 42 desirably has a given preserved length.

At this time, the housing 30 desirably includes a support surface 34 formed on the underside thereof in such a manner as to roundedly protrude downwardly from the underside of the support part 30b.

That is, the center of the underside of the housing 30 protrudes more downwardly than the underside of the support part 30b, thereby forming the support surface 34. Further, the support surface 34 and the underside of the support part 30b are desirably connected to each other by means of rounded profiles.

Accordingly, the wearer's head is supported softly by means of the support surface 34 in such a manner as to be spaced apart from the underside of the support part 30b, thereby removing the inconveniences caused by direct contacting his or her head with the coupling portions 32 and the slits 35 formed on the underside of the support part 30b, such as fitting, scratching, foreign body sensation and the like.

On the other hand, the lower end periphery of the rotary cover 20 is supportingly coupled to the top surface portion of the fixing cap 40. In the state where the rotary cover 20 is coupled to the upper periphery of the housing 30, that is, it is set in position in such a manner where the lower end periphery of the rotary cover 20 comes into contact with the top surface portion of the fixing cap 40.

In the state where the fixing cap 40 is first fixed to the support part 30b through the elastic hooks 42, accordingly, the fixing cap 40 is supported additionally by the lower end periphery of the rotary cover 20, so that the fixing cap 40 can be more stably coupled by means of two-step fixing. Even if strong motions or external impacts are applied, accordingly, the wire tightening device 100 can be stably fixed to the object to be tightened, without any separation therefrom, thereby improving the stability of the product.

In this case, the rotary cover 20 may be coupled to the housing 30 by means of separate bolts, but desirably, it can be coupled to the housing 30 by means of hook protrusions 21 formed unitarily therewith through injection molding.

In more detail, the housing 30 has a ring-shaped cover coupling groove 31 formed concaved inwardly in a radial direction thereof along the height corresponding to the top surface portion of the fixing cap 40 along the outer peripheral surface thereof, and accordingly, the hook protrusions 21 protrude from the inner peripheral surface of the lower end of the rotary cover 20 in such a manner as to be insertedly and hook-coupled to the cover coupling groove 31.

Considering the height in the up and down directions of the fixing cap 40, the heights in the up and down directions of the hook protrusions 21, and the height in the up and down directions of the side wall portion of the rotary cover 20, at this time, the cover coupling groove 31 is desirably set in position in such a manner where the lower end portion of the hook-coupled rotary cover 20 comes into contact with the top surface portion of the fixing cap 40 coupled to the support part 30b.

In this case, each hook protrusion 21 has a side section of an inverted right triangle, so that the top surface thereof is flat and the lower portion thereof is inclined.

At this time, the rotary cover 20 is desirably made of a resin material which is light and has high stiffness and a given elastic force.

That is, the inner diameter of the rotary cover 20 corresponds to the outer diameter of the through body part 30a, and if the rotary cover 20 is located on top of the through body part 30a, the inclined portions of the lower portions of the hook protrusions 21 face the top end periphery of the through body part 30a.

At this time, if the rotary cover 20 is pressurized toward the through body part 30a, the inclined portions of the lower portions of the hook protrusions 21 slide along the through body part 30a to cause given elastic deformation so that the inner diameter of the rotary cover 20 can be increased.

Further, if the hook protrusions 21 move along the outer peripheral surface of the through body part 30a and are then inserted into the cover coupling groove 31, the rotary cover 20 is elastically restored to allow the flat top surfaces of the hook protrusions 21 to be locked onto the stepped surface of the top of the cover coupling groove 31.

Accordingly, the rotary cover 20 can be easily coupled, while the lower end periphery of the rotary cover 20 is being located at a given height capable of supporting the top surface periphery of the fixing cap 40, thereby improving the assemblability of the product.

In this case, the hook protrusions 21 are formed in the circumferential direction along the inner periphery of the lower end portion of the rotary cover 20, and desirably, they are equally spaced apart from each other at given intervals.

For example, the hook protrusions 21 are located at two positions at intervals of 180° along the inner periphery of the lower end portion of the rotary cover 20, and so as to support the rotary cover 20 more stably upon the rotation of the rotary cover 20, more desirably, the hook protrusions 21 are located at three positions at intervals of 120° or at four positions at intervals of 90°.

As described above, the wire tightening device according to the present invention has the following advantages.

Firstly, only if the fixing cap pushes toward the support part, the elastic hooks are hook-coupled to the coupling portions, and then, the object to be tightened is fixedly clamped between the fixing cap and the support part, so that it is possible to install the wire tightening device on the object to be tightened only by means of one-touch pressurization, thereby remarkably improving the conveniences of use for the product.

Secondly, the separation hole from which the elastic hook is separated is formed on the side portion of the mounting hole onto which the elastic hook is locked, and only if the fixing cap rotates to a given angle, accordingly, the hook coupling is released, so that the maintenance and exchanging work can be easily performed, without any damage on the fabric.

Thirdly, the wedge protrusions formed on the fixing cap have the blade-shaped end portions having a given width in a radial direction, so that their fixing forces can be increased and the external force applied upon the manipulation of the wire tightening device is distributedly supported in the radial directions of the end portions of the wedge protrusions, thereby minimizing the damage of the fabric.

Lastly, the lower end periphery of the rotary cover is supportingly coupled to the top surface portion of the fixing cap, so that even if strong motions or external impacts are applied, accordingly, the fixing cap can be stably fixed to the rotary cover, without any separation therefrom, thereby improving the stability of the product.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A wire tightening device comprising:
a housing having a through body part adapted to be inserted into a coupling opening formed on an object to be tightened and having a cylindrical inner surface on which a ratchet type gear is formed and a support part protruding from the outer periphery of the lower portion of the through body part in such a manner as to be constrained on one surface of an edge peripheral portion of the coupling opening;
a rotary cover rotatably coupled to the top end periphery of the through body part in such a manner as to rotate by means of an external force;
a fastening part selectively engaged with the ratchet type gear in such a manner as to be constrained in rotation and adapted to apply a tensile force to a wire connected to both sides of the object to be tightened; and
a fixing cap having a coupling hole formed on the center thereof in such a manner as to insertedly pass the through body part therethrough to allow the fixing cap to be seated on the other surface of the edge peripheral portion of the coupling opening, while being pressurizedly coupled to the support part in such a manner as to clamp the edge peripheral portion of the coupling opening.

2. The wire tightening device according to claim 1, wherein at least one of the top of the support part and the underside of the fixing cap has a plurality of wedge protrusions formed thereon, the plurality of wedge protrusions becoming small in width in the circumferential direction thereof as the plurality of wedge protrusions goes toward the end portions thereof, so that the plurality of wedge protrusions is press-fitted to the edge peripheral portion of the coupling opening when the fixing cap comes into close contact with the support part.

3. The wire tightening device according to claim 1, wherein one of the top of the support part and the underside of the fixing cap has a plurality of elastic hooks formed thereon in such a manner as to be elastically deformed in a radial direction, each elastic hook having a locking protrusion formed on one surface of the inner surface and the outer surface of the end portion thereof, the locking protrusion having a stepped projection formed thereon, so that the plurality of elastic hooks passes through a plurality of through holes formed on the edge peripheral portion of the coupling opening, and the other of the top of the support part and the underside of the fixing cap has a plurality of coupling portions formed thereon in such a manner as to insertedly and lockedly couple the plurality of elastic hooks thereto.

4. The wire tightening device according to claim wherein each locking protrusion has an inclined portion formed inclinedly toward the other surface of the inner and outer surfaces of the end portion of each elastic hook as the locking protrusion goes toward the lower side along the portion corresponding to the lower portion of the stepped projection, and each coupling portion comprises a mounting hole having a locking projection formed on one side edge facing the inclined portion in such a manner as to lock the stepped projection thereonto and a separation hole connected to one side in the circumferential direction of the mounting hole in such a manner as to be expanded on one side edge to separate the stepped projection therefrom.

5. The wire tightening device according to claim 1, wherein while the lower end periphery of the rotary cover is being supportingly coupled to the top surface portion of the fixing cap, the housing has a ring-shaped cover coupling groove formed concaved inwardly in a radial direction thereof along the height corresponding to the top surface portion of the fixing cap along the outer peripheral surface thereof, the rotary cover has a plurality of hook protrusions protruding from the inner peripheral surface of the lower end thereof in such a manner as to be insertedly and hook-coupled to the cover coupling groove, and the housing has a support surface formed on the underside thereof in such a manner as to roundedly protrude downwardly from the underside of the support part.
